(19) United States
(12) Patent Application Publication
(10) Pub. No.: US 2013/0317919 A1
(43) Pub. Date: Nov. 28, 2013

(54) SYSTEM AND METHOD FOR MULTIMEDIA CONTENT PUBLISHING ON MULTIPLE PLATFORMS

(71) Applicant: One Mainstream, Inc., Saratoga, CA (US)

(72) Inventors: Rajeev Raman, Cupertino, CA (US); Daniel Zuck, Santa Clara, CA (US)

(73) Assignee: One Mainstream, Inc., Saratoga, CA (US)

(21) Appl. No.: 13/875,136

(22) Filed: May 1, 2013

Related U.S. Application Data
(60) Provisional application No. 61/641,841, filed on May 2, 2012.

(51) Int. Cl. H04L 29/06

(52) U.S. Cl. CPC H04L 65/60
USPC 705/14.73; 715/753

(57) ABSTRACT

A system and method for multimedia content publishing on multiple platforms are herein disclosed. According to one embodiment, the computer-implemented method includes receiving specified settings from a plurality of configurable template settings for a custom channel application, receiving specified platforms from a plurality of platforms for the custom channel application; publishing the custom channel application to each of the specified platforms, and providing a user interface of the custom channel application that is customized based on each of the specified platforms.

The present application claims the benefit of and priority to U.S. Provisional Patent Application No. 61/641,841 entitled “SYSTEM AND METHOD FOR MULTIMEDIA CONTENT PUBLISHING ON MULTIPLE PLATFORMS” filed on May 2, 2012, the disclosure of which is hereby incorporated by reference in its entirety.

### FIELD

The present disclosure relates in general to the field of content publishing. In particular, the present disclosure relates to a system and method for multimedia content publishing on multiple platforms.

### BACKGROUND

Multimedia content publishing has evolved in many ways and still continues to evolve. The television is significantly the first platform to enable content providers (e.g., content owners, creators, aggregators and advertisers) to publish and deliver multimedia content to households en masse. The personal computer and the Internet are other significant platforms that publish and deliver multimedia content. Recently, the emergence of consumer electronic devices with Internet access have created an explosion in the number of new platforms that are available to content providers. For example, these platforms include GOOGLE TV®, GOOGLE® ANDROID®, ROKU®, MICROSOFT® XBOX 360®, SONY® PLAYSTATION 3®, APPLE® IOS®, AMAZON KINDLE FIRE®, and the NINTENDO® WII®.

Multimedia content is typically delivered to these platforms as applications that are purchased (or provided for free) and downloaded via an online application store or market (e.g., iTunes and Google Play) by users (herein referred to as viewers). Applications refer to software programs that are designed to run on a particular platform. Applications include, but are not limited to, games as well as software for accessing video/audio clips and streams. Applications that provide access to video/audio content from a content provider are herein referred to as custom channels. For example, NETFLIX®, a content provider, provides a custom channel for the GOGGLE® ANDROID® platform and allows subscribers to access on-demand video streams on their ANDROID® devices. NETFLIX® also provides a custom channel for various devices such as APPLE® IOS® devices, ROKU® devices, MICROSOFT® XBOX 360®, SONY® PLAYSTATION 3®, and NINTENDO® WII®.

Applications, including custom channels are typically platform-specific. Therefore, content providers are required to develop these applications specific to each platform. Custom application development may require content providers to internally develop each application for target platforms or work with third-party programmers if the content providers do not have the programming expertise. Thus, the process of launching a custom channel on multiple platforms becomes costly and time consuming.

### SUMMARY

A system and method for multimedia content publishing on multiple platforms are herein disclosed. According to one embodiment, the computer-implemented method includes receiving specified settings from a plurality of configurable template settings for a custom channel application, receiving specified platforms from a plurality of platforms for the custom channel application; publishing the custom channel application to each of the specified platforms, and providing a user interface of the custom channel application that is customized based on each of the specified platforms.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying figures, which are included as part of the present specification, illustrate the presently preferred embodiments of the present invention and together with the general description given above and the detailed description of the preferred embodiments given below serve to explain and teach the principles of the present invention.

FIG. 1 illustrates a flowchart of an exemplary process for publishing content to custom channels, according to one embodiment.

FIG. 2 illustrates an exemplary interface template for editing or adding a new custom channel, according to one embodiment.

FIG. 3 illustrates an exemplary interface template for configuring channel information for a custom channel, according to one embodiment.

FIG. 4 illustrates an exemplary interface template for uploading content files, according to one embodiment.

FIG. 5 illustrates an exemplary interface template for configuring the mode of adding content and DRM, according to one embodiment.

FIG. 6 illustrates an exemplary interface template for configuring category settings, according to one embodiment.

FIG. 7 illustrates an exemplary interface template for configuring live events and live playlists, according to one embodiment.

FIG. 8 illustrates an exemplary interface template for configuring an aspect ratio for a type of custom channel, according to one embodiment, according to one embodiment.

FIG. 9 illustrates an exemplary interface template for configuring a title bar, according to one embodiment.

FIG. 10 illustrates an exemplary interface template for configuring a background screen and welcome screen, according to one embodiment.

FIG. 11 illustrates an exemplary interface template for configuring pricing settings, according to one embodiment.

FIG. 12 illustrates an exemplary interface template for configuring feature settings, according to one embodiment.

FIG. 13 illustrates an exemplary interface template for configuring rating reminder settings and external authentication, according to one embodiment.

FIG. 14 illustrates an exemplary interface template for specifying platforms for publishing the content, according to one embodiment.

FIG. 15 illustrates a block diagram of an exemplary publishing system for delivering a customized user interface of a custom channel to various platforms.

FIG. 16 illustrates a block diagram of an exemplary publishing system, according to one embodiment.

FIG. 17 illustrates a block diagram of an exemplary system for delivering an on demand video file to a device, according to one embodiment.

FIG. 18 illustrates a block diagram of an exemplary system for delivering a live event to a device, according to one embodiment.

FIG. 19 illustrates a block diagram of an exemplary process of activating a device with a social network, according to one embodiment.

FIG. 20 illustrates an exemplary data model that is used for the present system, according to one embodiment, according to one embodiment.

FIG. 21 illustrates an exemplary computer architecture that may be used for the present system, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

A system and method for multimedia content publishing on multiple platforms are herein disclosed. According to one embodiment, the computer-implemented method includes receiving specified settings from a plurality of configurable template settings for a custom channel application, receiving specified platforms from a plurality of platforms for the custom channel application; publishing the custom channel application to each of the specified platforms, and providing a user interface of the custom channel application that is customized based on each of the specified platforms.

Each of the features and teachings disclosed herein can be utilized separately or in conjunction with other features and teachings to provide a method for reducing the order of system models exploiting sparsity. Representative examples utilizing many of these additional features and teachings, both separately and in combination, are described in further detail with reference to the attached figures. This detailed description is merely intended to teach a person of skill in the art further details for practicing preferred aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

According to one embodiment, the present system provides automated building of native applications for streaming devices that are supported by various platforms. The present system provides an automated generation of artwork (e.g., icons, logos, backgrounds and other graphics) on the user interface of the custom channel application for a variety of video streaming devices from a single configuration of templates and settings. The single configuration of templates and settings are discussed in detail below. For example, the present system provides a web user interface to apply this single configuration of templates and settings.

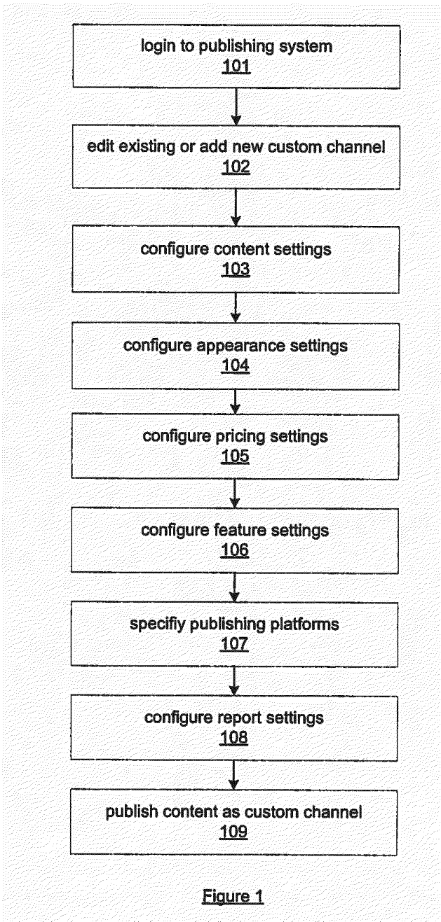

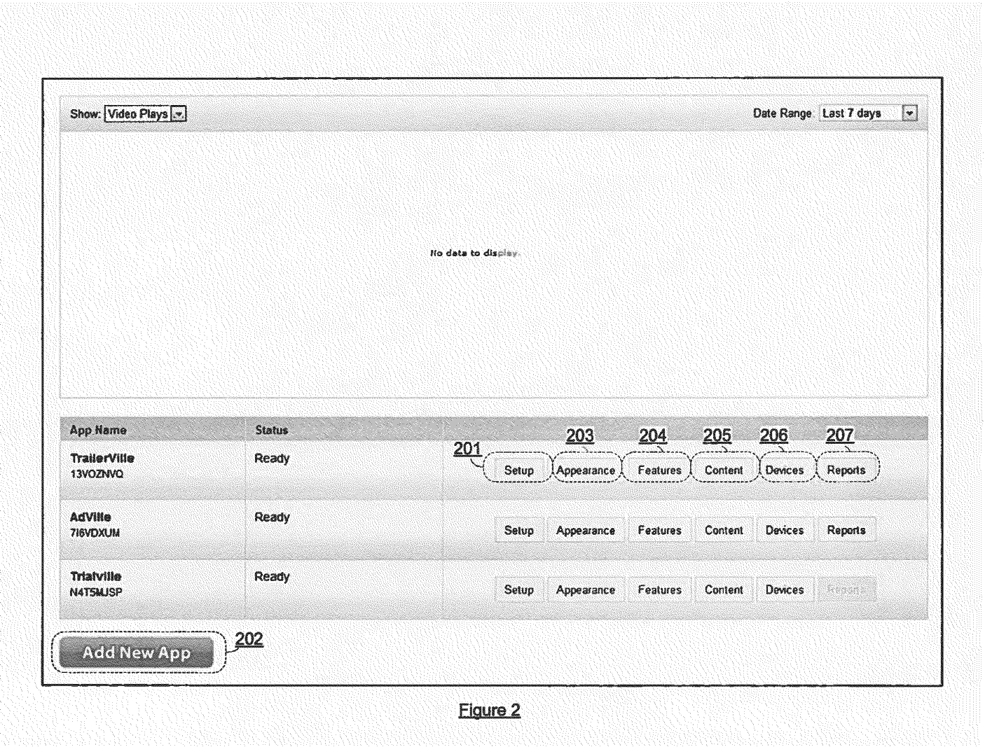

FIG. 1 illustrates a flowchart of an exemplary process for publishing content to custom channels, according to one embodiment. At 101, a content provider logs into a publishing system via a web interface. After logging in, the content provider chooses to edit an existing custom channel or add a new custom channel at 102. FIG. 2 illustrates an exemplary interface template for editing or adding a new custom channel, according to one embodiment. The content provider may either select a setup option 201 of an existing channel (e.g., TrailerVille) to edit channel information or select an add new application option 202 to add a new custom channel.

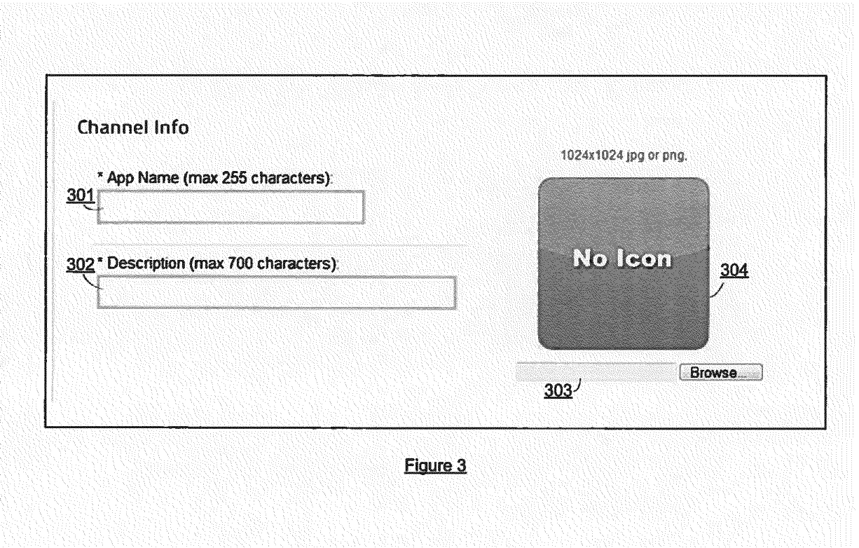

After the content provider selects a setup option 201 or an add new application option 202, he/she can configure channel information for the custom channel as illustrated in FIG. 3. FIG. 3 illustrates an exemplary interface template for configuring channel information for a custom channel, according to one embodiment. The channel information includes, but is not limited to, selectable fields for configuring an application name 301, an application description 302, and an application icon 303. The content provider is provided with an icon preview 304 after configuring the application icon 303.

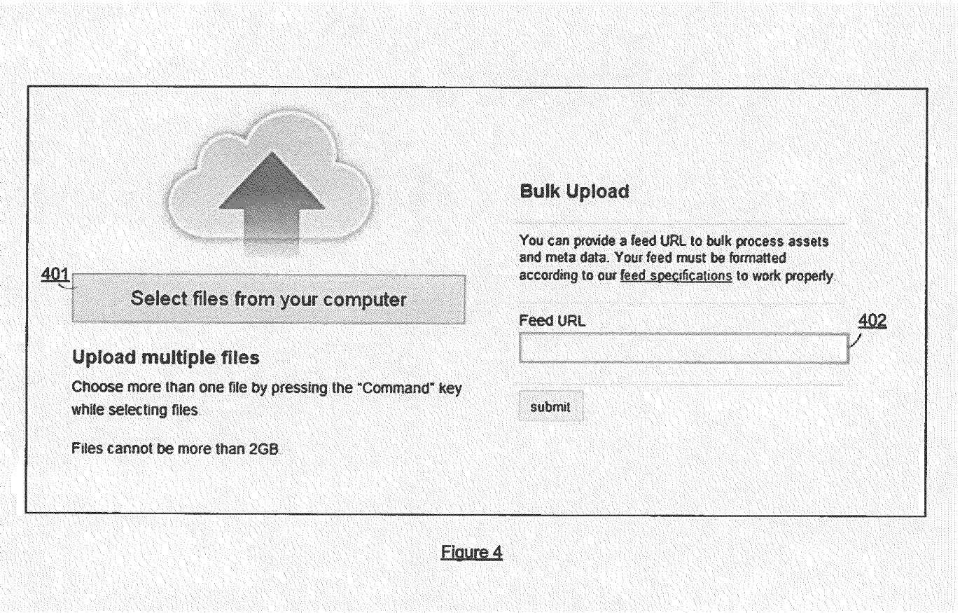

Referring to FIG. 1, the content provider configures the content settings for the custom channel at 103. The content provider selects a content option 205 in FIG. 2 that includes configuration of content such as uploading content files, configuring the mode of adding content, digital rights management (DRM) for the content files, category settings and live events/playlists. In one embodiment, after the content provider selects the content option 205, he/she may choose to upload a content file as illustrated in FIG. 4. FIG. 4 illustrates an exemplary interface template for uploading content files, according to one embodiment. The content provider uploads content files by selecting files 401 from a device (e.g., computer, laptop) or provide a feed uniform resource locator (URL) 402. The content provider may upload a variety of content files, including an image, an audio, a video, a document and an executable). The content provider may upload video format content files in a variety of input formats and codecs (e.g., Moving Picture Experts Group MPEG2, MPEG4, and flash video FLV), aspect ratios (e.g., 21:9, 16:9 and 4:3) and resolution (e.g., 480p, 720p and 1080p).

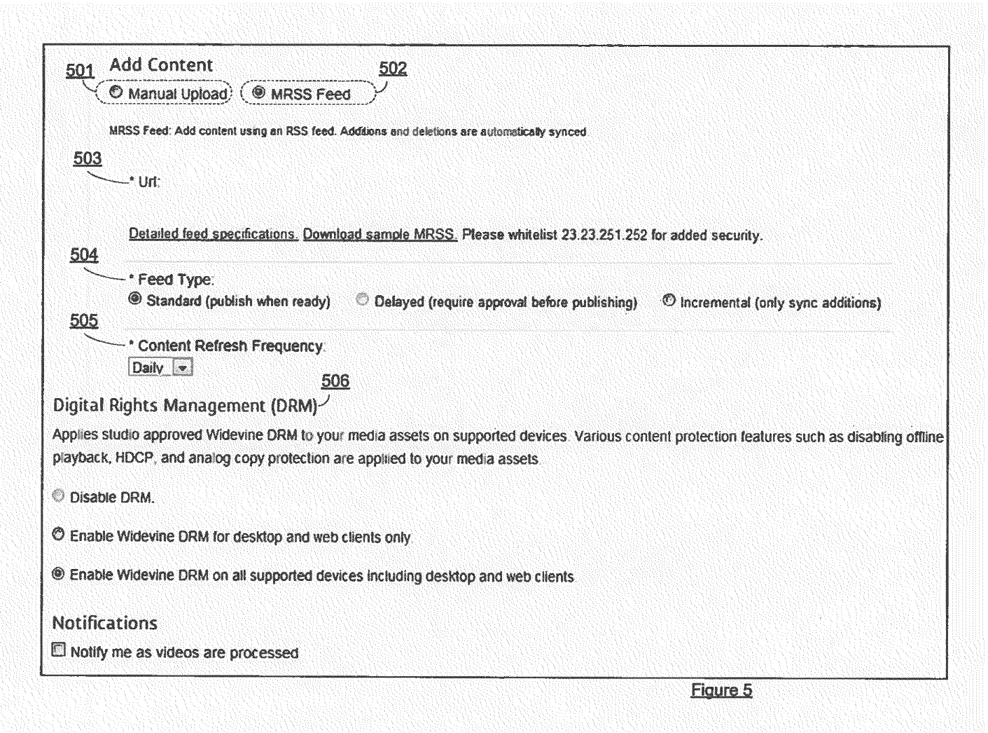

In another embodiment, after the content provider selects the content option 205, he/she may choose to configure the mode of adding content and DRM as illustrated in FIG. 5. FIG. 5 illustrates an exemplary interface template for configuring the mode of adding content and DRM, according to one embodiment. The content provider selects a mode of adding content by either selecting a manual upload 501 of content files or selecting a content feed 502 (e.g., media rich site summary (MRSS) feed) to provide content files. If the content provider selects the content feed 502 to add content files, the content provider provides a feed URL 503 to supply the content files. The content provider further selects a feed type 504 of the content feed 502, such as publishing the feed when ready, approving the feed before publishing, or publishing only synchronized additions. The content provider further specifies the content refresh frequency 505 (e.g., hourly, daily, weekly) of the content feed 502.

The content provider further selects an encryption setting 506 (e.g., digital rights management (DRM)) to enable content protection features such as disabling offline playback, high-bandwidth digital content protection (HDCP), and analog copy protection on uploaded media content files. The encryption settings include, but not limited to, selectable fields for disabling encryption, and enabling encryption for devices (e.g., desktop and web clients).

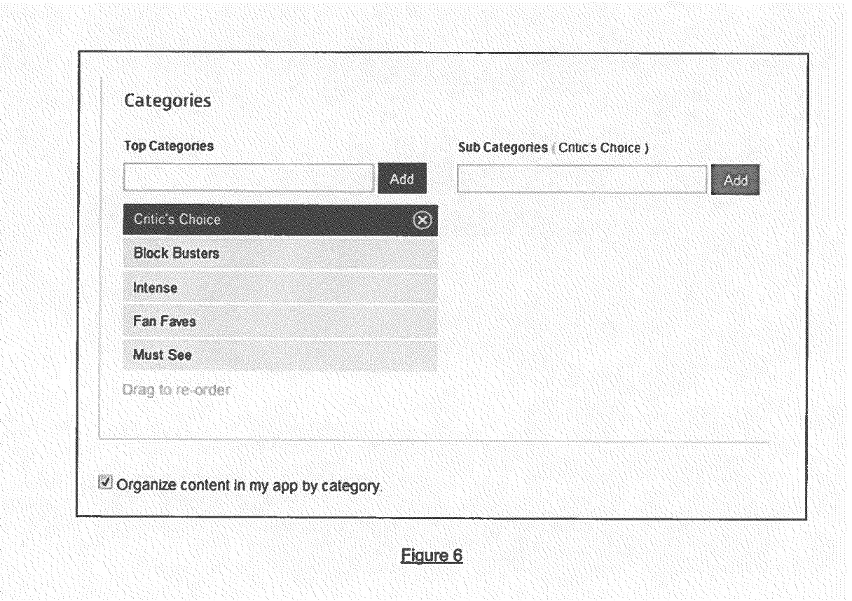

In another embodiment, after the content provider selects the content option 205, he/she may choose to configure the category settings that categorizes the content files, as illustrated in FIG. 6. FIG. 6 illustrates an exemplary interface template for configuring category settings, according to one embodiment. The category settings include, but are not limited to, selectable fields for adding new categories, re-arranging and deleting categories. The content provider may dynamically re-arrange the display order of the categories for the custom channel. According to one embodiment, the content provider specifies one or more subcategories for a category.

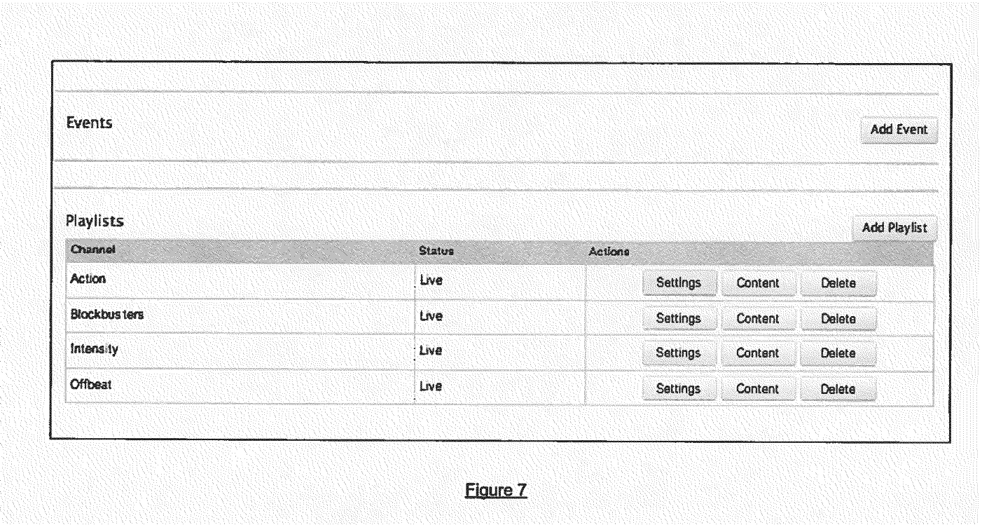

In another embodiment, after the content provider selects the content option 205, he/she may choose to configure live events and live playlists as illustrated in FIG. 7. FIG. 7 illustrates an exemplary interface template for configuring live events and live playlists, according to one embodiment. The content provider creates a live event to automatically provision a real-time streaming of a live event (e.g., a baseball match). The live event settings include, but are not limited to, selectable fields for specifying the name, description, poster, start time, always on/one time for the event. The content provider may add or delete a live event that has been already created. In another embodiment, the content provider creates a live playlist to specify content that starts at a pre-defined time based on a schedule. The content scheduled on the live playlist includes videos of content files that are uploaded to a database of the present system by the content provider. The content provider can insert content in between videos to re-arrange the playing time of the content. The live playlist settings include, but are not limited to, selectable fields for specifying the name, description, poster, and a schedule of content to play. The content provider may add or delete a live playlist that has been already created. According to one embodiment, the content provider selects a content to be played at a pre-defined time by dragging the content file to the pre-defined time on a timeline via a user interface.

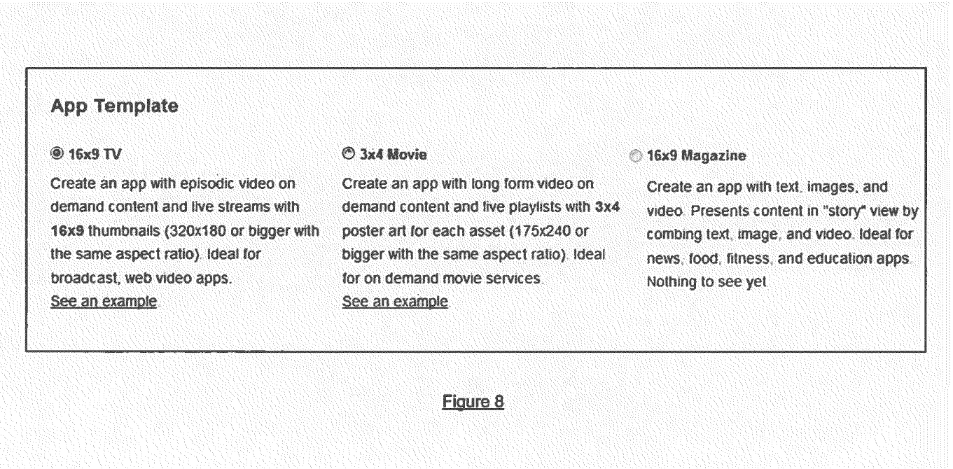

Referring to FIG. 1, the content provider configures the appearance settings for the custom channel at 104. The content provider selects an appearance option 203 in FIG. 2 to configure appearance settings that include, but are not limited to, selectable fields for configuring an aspect ratio for a type of custom channel, a title bar, a screen and a welcome screen. After the content provider selects the appearance option 203, he/she may configure an aspect ratio for a type of custom channel as illustrated in FIG. 8. FIG. 8 illustrates an exemplary interface template for configuring an aspect ratio for a type of custom channel, according to one embodiment. The application template includes, but are not limited to, selectable fields for choosing the type of application display template layout according to the type of uploaded content files. For example, the content provider selects a TV template layout to create a custom channel with on demand episodic content (e.g., drama series) and live video streams. The content provider may select a movie template layout to create a custom channel with on demand long form video (e.g., movies) and live playlists. The content provider may select a magazine template layout to create a custom channel with a story-like view that combines text, images and videos.

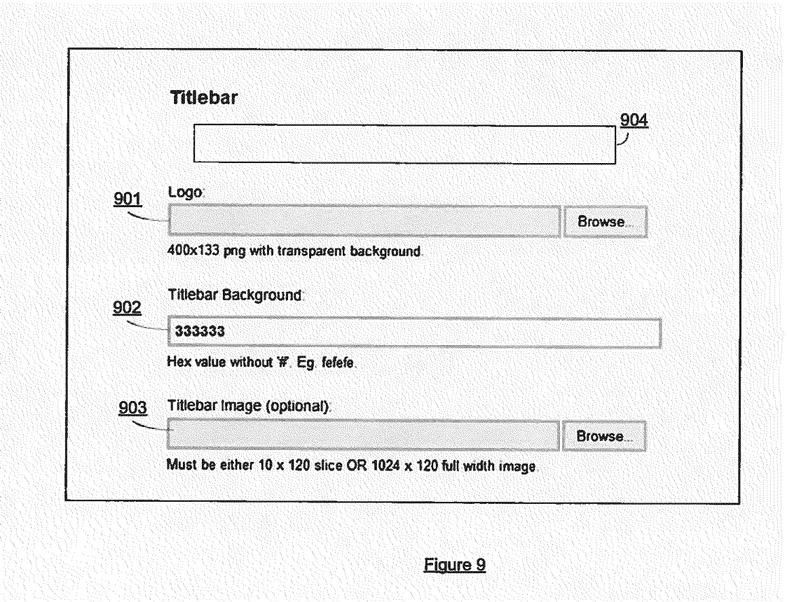

In one embodiment, after the content provider selects the appearance option 203, he/she may configure a title bar, as illustrated in FIG. 9. FIG. 9 illustrates an exemplary interface template for configuring a title bar, according to one embodiment. The title bar fields include, but are not limited to, selectable fields for specifying a logo 901, a background color 902 and a title bar image 903. The content provider is provided with an title bar preview 904 after specifying the title bar fields.

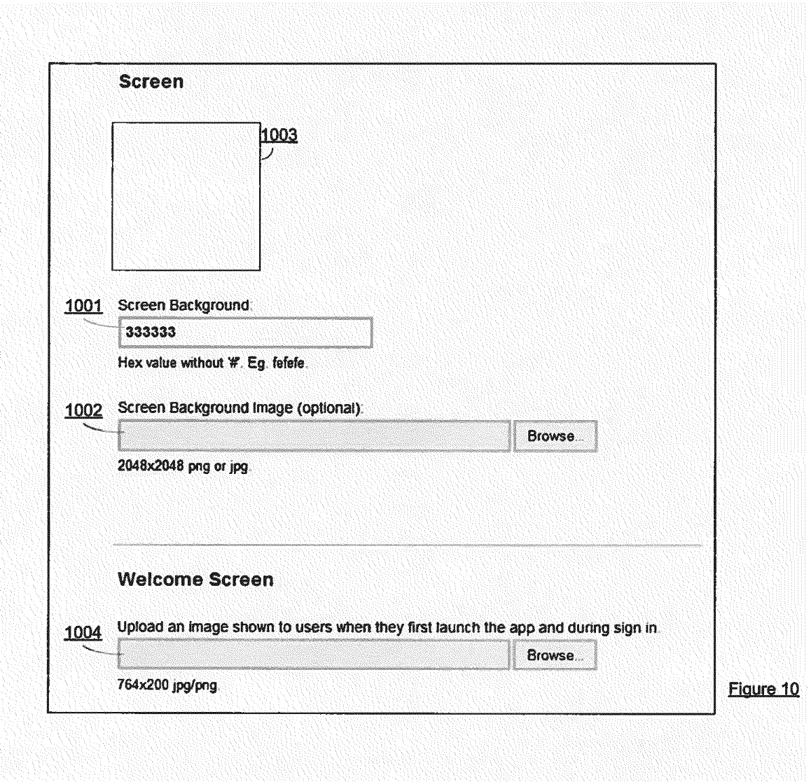

In another embodiment, after the content provider selects the appearance option 203, he/she may configure a background screen and welcome screen, as illustrated in FIG. 10. FIG. 10 illustrates an exemplary interface template for configuring a background screen and welcome screen, according to one embodiment. The background screen fields include, but are not limited to, selectable fields for specifying a background color 1001 and a screen background image 1002. The content provider is provided with a screen preview 1003 after specifying the background screen fields. The welcome screen field includes, but is not limited to, a selectable field for specifying a welcome screen image 1004.

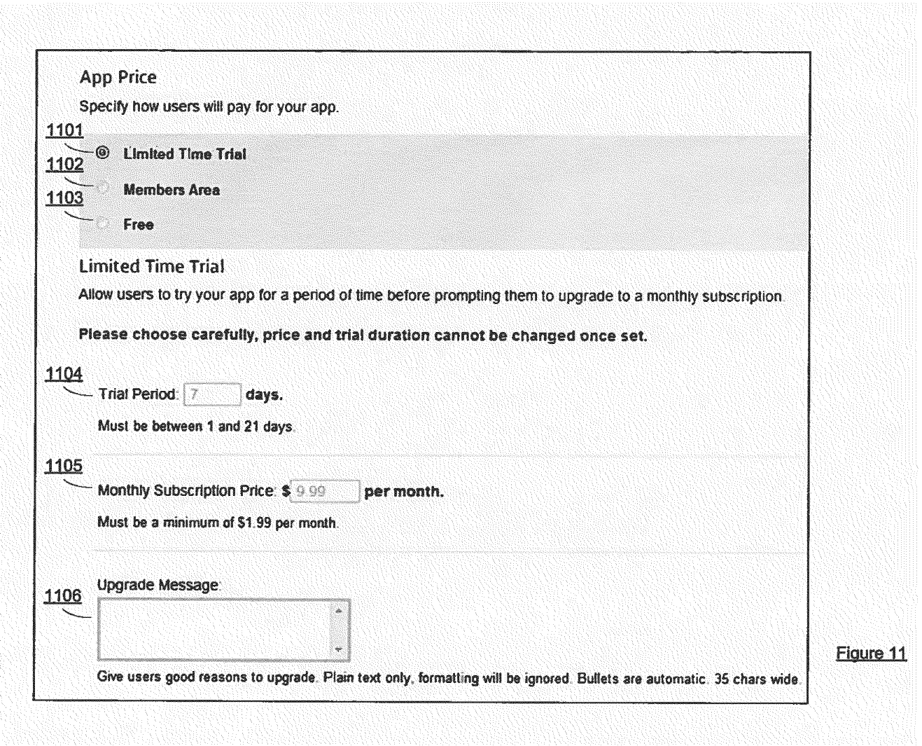

Referring to FIG. 1, the content provider configures the pricing settings for the custom channel at 105. FIG. 11 illustrates an exemplary interface template for configuring pricing settings, according to one embodiment. The pricing settings include, but are not limited to, selectable fields for specifying how users pay for the custom channel. For example, the content provider specifies whether the content is available for free 1103, free for a limited time trial 1101 or a members' area 1102 based on subscription (e.g., pay through an online application store). If the content is free for a limited time trial 1101, the content provider specifies the length of the trial period 1104, a cost of the custom channel at the expiration of the trial period (e.g., a monthly subscription price 1105), the benefits 1106 to upgrade the free trial service, and other promotional graphics.

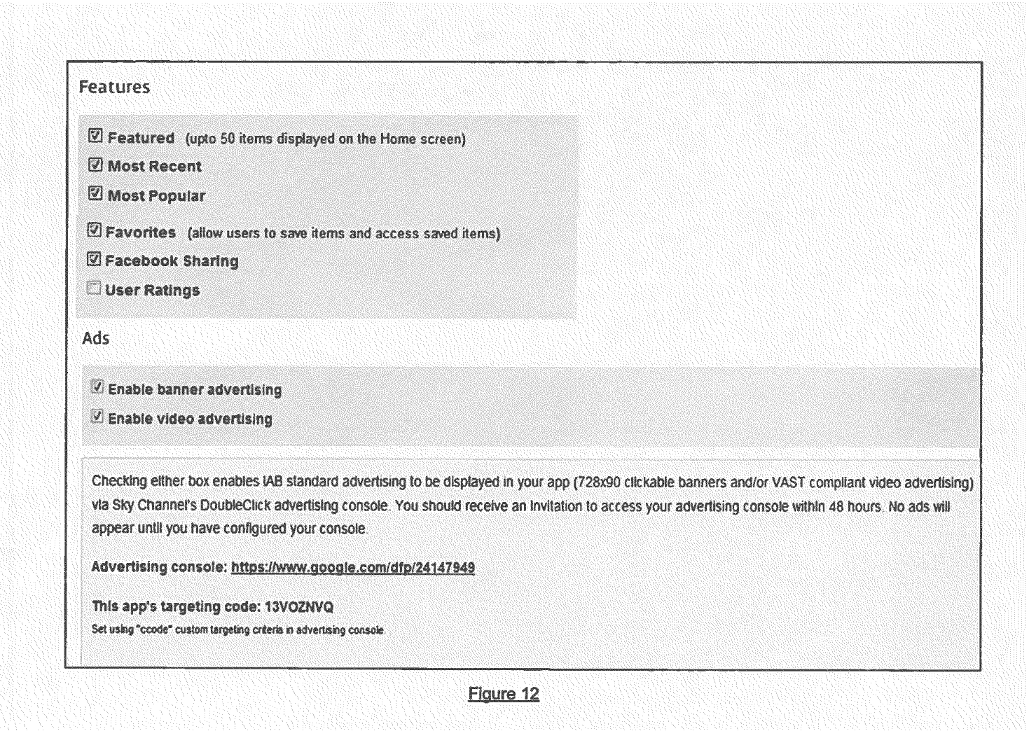

Referring to FIG. 1, the content provider configures the feature settings for the custom channel at 106. The content provider selects a feature option 204 in FIG. 2 to configure feature settings. FIG. 12 illustrates an exemplary interface template for configuring feature settings, according to one embodiment. The feature settings include, but are not limited to, selectable fields for specifying content filters, listing features for generating lists (e.g., a “Featured” list, a “Most Recent” list, a “Most Popular” list, and a “Favorites” list), features for sharing on a social media network (e.g., FACEBOOK® sharing), user ratings, and type of advertisements to be displayed (e.g., banner advertising, video advertising).

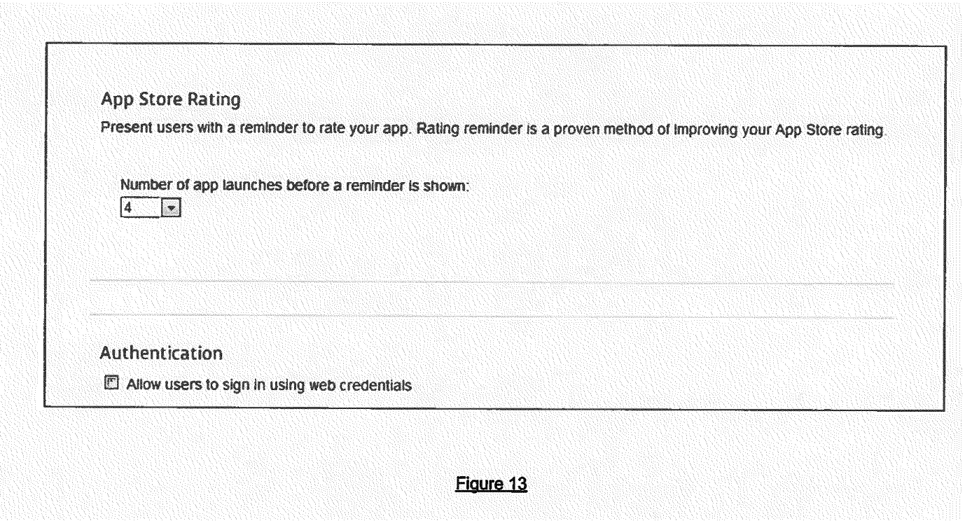

The content provider may further select the feature option 204 in FIG. 2 to configure rating reminder settings and external authentication. FIG. 13 illustrates an exemplary interface template for configuring rating reminder settings and external authentication, according to one embodiment. The content provider configures a frequency of rating reminders to users, for example selecting a number of application launches by a viewer before a reminder is shown to the viewer.

According to one embodiment, the present system includes a database of viewers with associated authentication information (e.g., user ID and password) for user authentication. In another embodiment, the content provider selects the authentication option utilize authentication information from the content provider's own viewer database for user authentication. The present system allows the content provider to provide a login URL and validation URL to grant access to viewers from the content provider's own viewer database. The login URL and validation URL may contain macros to replace information regarding the custom channel from the present system. For example, the login URL and validation URL contains a username macro to replace a user ID on a device. Other macros include a password, a device ID, an operating system (e.g., APPLE® IOS®, and GOOGLE® ANDROID®), a version of the operating system, a platform (e.g., APPLETV®, IPAD®, tablet and a device that may share an operating system with different hardware (e.g., IPHONE® and IPAD® share the IOS® operating system)). The values of these macros replaces the original information stored on the system at the time the present system sends an external authentication API during authentication. This allows the present system to gain access to an existing viewer database of the content provider. In another embodiment, the present system provides user authentication for a third party verification (e.g., a social network) by sending a device activation API as described in further detail below.

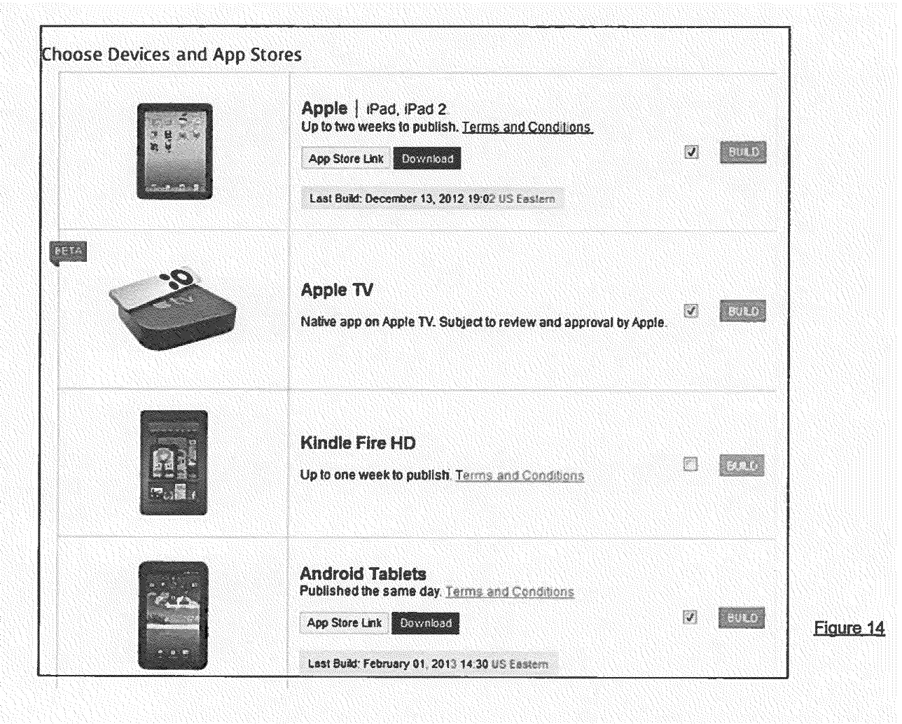

Referring to FIG. 1, the content provider specifies one or more publishing platforms to publish the content at 107. After the content provider selects a devices option 206 in FIG. 2, he/she may specify one or more publishing platforms as illustrated in FIG. 14. Exemplary publishing platforms include, but are not limited to, ROKU® devices, GOOGLE TV®, AMAZON® KINDLE FIRE®, ANDROID® tablets, SAMSUNG SMART TV®, APPLE® IOS® devices, MICROSOFT® XBOX 360®, NINTENDO® WII°, SONY® PLAYSTATION 3®, YOUTUBE®, FACEBOOK®, and various websites. FIG. 14 illustrates an exemplary interface template for specifying platforms for publishing the content, according to one embodiment. The content provider may further select a reports option 207 in FIG. 2 to track the traffic associated with accessing the content (e.g., via Google Analytics).

Referring to FIG. 1, although 103 through 108 are described and illustrated as being performed in a particular order, it is understood by one of ordinary skill in the art that the ordering of those steps are interchangeable. For example, the content provider may configure the pricing settings at 105 prior to configuring the content settings at 103. At 109, the content provider publishes the content as a custom channel to the specified platform(s). According to one embodiment, the content provider publishes the content in real-time. In another embodiment, the content provider publishes the custom channel after editing an existing or adding a new custom channel at 102. The content provider publishes the custom channel after configuring the application name 301 and the application description 302. In this case, the present system publishes a basic custom channel with default artwork (e.g., icons, logos, and background) since they are not provided by the content provider. For example, the content provider may publish the custom channel for testing purposes.

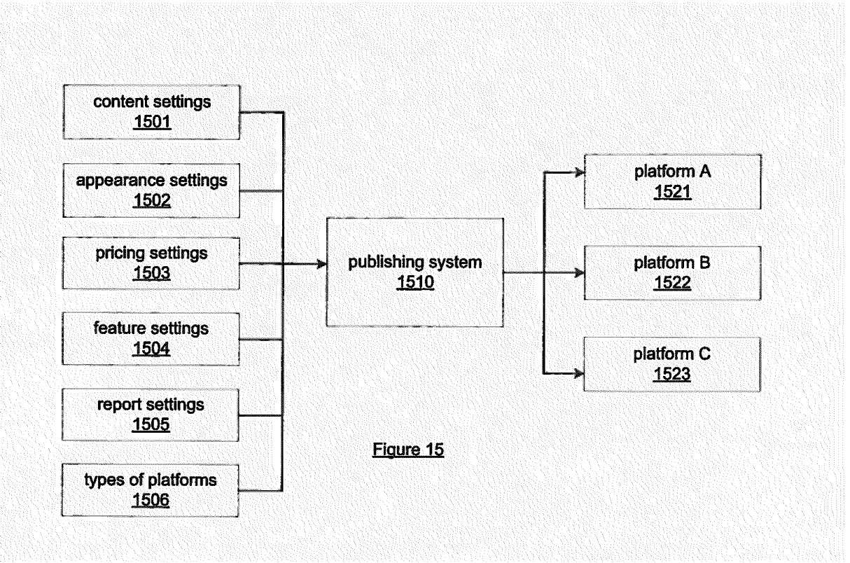

FIG. 15 illustrates a block diagram of an exemplary publishing system for delivering a customized user interface of a custom channel to various platforms, according to one embodiment. The publishing system 1510 receives a single configuration of various templates for a custom channel such as content settings 1501, appearance settings 1502, pricing settings 1503, feature settings 1504, and report settings 1505. The publishing system customizes the configuration of the templates to generate a customized user interface of the custom channel based on each type of platform. The publishing system transforms uploaded images (e.g., the logo 901, the title bar image 903 and the welcome screen image 1004) into various sizes and formats. The publishing system generates new images by a variety of methods, including combining two or more uploaded images, combining hex codes (e.g., the title bar background color 902 and the screen background color 1001) and uploaded images, and generating new images from hex codes. These new images provide the artwork (e.g., splash screens, title bars, and backgrounds) of the custom channel application.

According to one embodiment, the publishing system allows the content provider to specify an order of content by category so that content in a top category is highlighted on the user interface (e.g., displayed at the top of the user interface) of the custom channel.

According to another embodiment, the publishing system allows the content provider to tag a content as a featured content. The publishing system provides a spotlight image for the featured content, that highlights the featured content on the user interface of the custom channel. According to another embodiment, the content provider selects features, as illustrated in FIG. 12, so that content based on the selected features (e.g., favorites, featured, and most recent) are highlighted on the user interface of the custom channel. The above embodiments illustrate that the publishing system processes the content provider's configurations of a common settings template such as uploaded images, selected feature settings, and content organization to create a customized user interface for the custom channel application. The publishing system provides a build process that replaces configurations from the settings templates (e.g., a logo, and a background) with macros/placeholders For example, an input for the application name 301 specified on an ANDROID® platform is replaced by a value % SKY % TITLE % SKY % at build time. 1506. In this case, the publishing system provides a customized user interface of the custom channel for platform A 1521, platform B 1522, and platform C 1523. Although FIG. 15 only illustrates three platforms, the publishing system 1510 is scalable and may support any number and/or type of platforms.

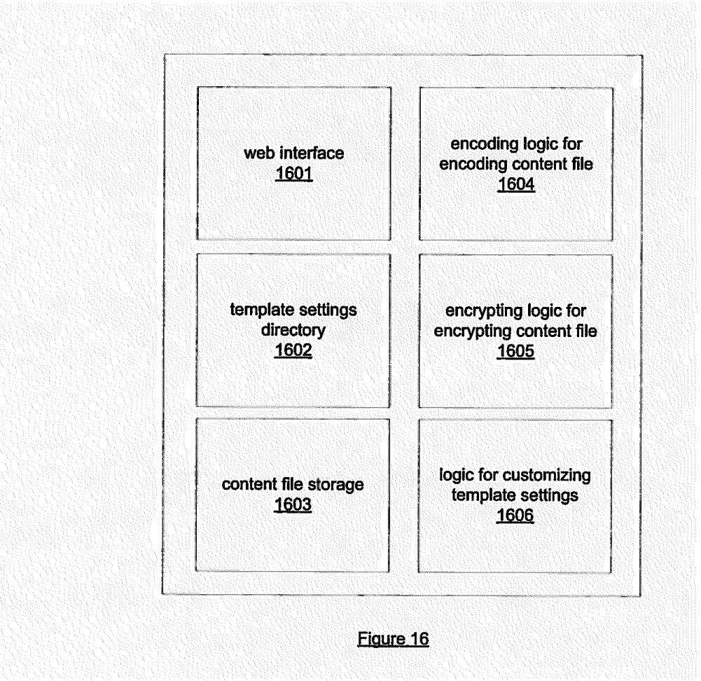

FIG. 16 illustrates a block diagram of an exemplary publishing system, according to one embodiment. The publishing system includes a web interface component 1601, a template settings directory 1602, content file storage 1603, an encoding logic component 1604 for encoding content files, an encrypting logic component 1605 for encrypting content files, and a logic component 1605 for customizing template settings. It is contemplated that these components may be combined or divided into sub-components, and that the publishing system or its components may be implemented using software elements, hardware elements, or a combination of software and hardware elements. Such variations are within the scope of the present subject matter.

The web interface component 1601 provides the web interface that allows the content provider to interact with the publishing system. The web interface component 1601 provides various template settings of the custom channel for the content provider to configure. The template settings directory 1602 is a directory of various template settings that the content provider may configure, such as content settings, appearance settings, pricing settings, feature settings, and report settings. The content file storage 1603 provides a database for storing content files uploaded by the content provider to the publishing system. According to one embodiment, the content file storage 1603 stores content files that are downloaded from a content feed provided by the content provider.

The encoding logic component 1604 includes logic for encoding content files based on the platforms and settings specified by the content provider. The encrypting logic component 1605 includes logic for encrypting content files based on digital rights management (DRM) settings and platforms specified by the content provider. The logic component 1605 includes logic for customizing template settings to provide a customized user interface that is adapted to each platform specified by the content provider.

According to one embodiment, the published custom channel allows a user to pause playback (e.g., watch a movie, listen to music) on one device and resume at a later time on a different device. The two devices providing the published custom channel may be of the same or a different platform type.

According to one embodiment, the published custom channel supports 240-1080p adaptive bit rate (ABR) streaming (e.g., HTML Live Streaming) which modifies the resolution of the streaming media depending on the speed/quality of the data connection. The published custom channel supports content queuing, RSS/XML/API content synching, content promotion via a closed viral loop, and a third-party single sign-on feature (e.g., FACEBOOK° for viewers.

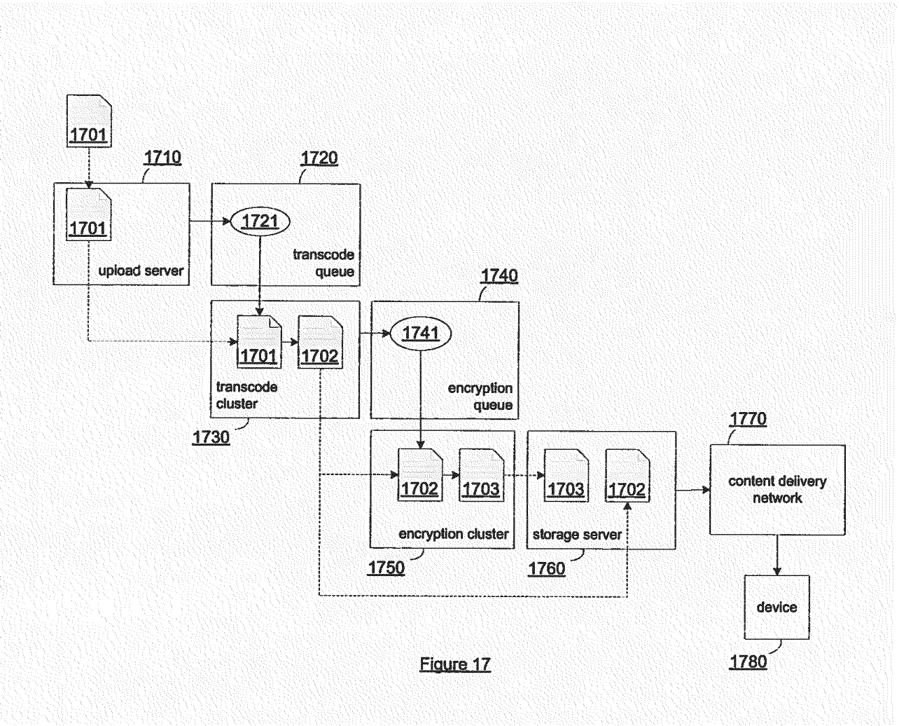

FIG. 17 illustrates a block diagram of an exemplary system for delivering an on demand video file to a device, according to one embodiment. A content provider uploads a content file 1701 with a particular video format to an upload server 1710. The content file 1701 may be uploaded from the content provider's local drive (e.g., computer, laptop) or provided as a content feed. The upload server 1710 stores the content file 1701. If the content file 1701 is uploaded from a content feed, the upload server 1710 parses the feed URL of the content feed, and evaluates changed items from the feed URL. The upload server 1710 further contains the configurations and setting of various templates (e.g., content settings, appearance settings and pricing settings) for a custom channel and publishing platforms to publish the custom channel as specified by the content provider.

The upload server 1710 evaluates video assets from the content file 1701 that require encoding. According to one embodiment, the content file 1701 requires encoding into a target encoded video format that is suitable for playback on a platform specified by the content provider. The content file 1701 may be encoded into one or more target encoded video formats based on a number of platforms specified by the content provider. In another embodiment, the content file 1701 requires encoding into a target encoded video format based on the application display template (e.g., TV template, movie template and magazine template) illustrated in FIG. 8. For example, the content provider specifies a platform that supports a particular video format or a platform that supports a device having limited storage capacity, thus mandating a reduced file size. In order to instantiate content encoding, the upload server 1710 posts a transcode message 1721 in a transcode queue 1720 (e.g., AMAZON® Simple Queue Service (SQS) provided by AMAZON WEB SERVICES®). According to one embodiment, the transcode message 1721 includes a pointer to the content file 1701 and a target encoded video format to encode from the content file 1701.

The transcode cluster 1730 reads the transcode message 1721 from the transcode queue 1720 and downloads the content file 1701 from the upload server 1710. According to one embodiment, transcode cluster 1730 downloads the content file 1701 via a hypertext transfer protocol (HTTP) GET request or stores it on a storage server (e.g., AMAZON® Simple Storage Service (S3)). For example, the upload server 1710 stores a content file 1701 that is manually uploaded by a content provider on a storage server and transfers the content file 1701 to the transcode cluster 1730 using a download software development kit (SDK) (e.g., AMAZON®) The download SDK provides a HTTP GET with user authentication of the content provider. If the content file 1701 is from a content feed, the content provider provides the upload server 1710 with access to the content feed by a proxy through the upload server 1710 so that the content provider only allows download access for the upload server 1710. The proxy access provides security in the form of user authentication or client certificates, according to one embodiment. The transcode cluster 1730 encodes the video in the content file 1701 into the target encoded video format 1702. According to one embodiment, the content file 1701 is encoded up to a maximum of 1080p resolution, 29.97 fps with H264 and advanced audio coding (AAC) codecs. The target encoded video format 1702 is encoded up to the maximum resolution of the content file 1701. During encoding, the aspect ratio of the content file 1701 is preserved. The transcode cluster 1730 may transcode the video in the content file 1701 into one or more target encoded video formats. According to one embodiment, the transcode cluster 1730 is based on an online web service (e.g., AMAZON® Elastic Compute Cloud (EC2) provided by AMAZON WEB SERVICES®) that provides resizable compute capacity in the cloud. The transcode cluster 1730 deletes the content file 1701 after transcoding is complete so that the transcode cluster 1730 is de-provisioned, according to one embodiment.

The transcode cluster 1730 posts a encrypt message 1741 to an encryption queue 1740 (e.g., AMAZON® Simple Queue Service (SQS) provided by AMAZON WEB SERVICES″). The encrypt message 1741 includes a pointer to the encoded video format 1702 and to a target encrypted video stream 1703. According to one embodiment, the target encrypted video stream 1703 is based on the specified platform and encrypted settings provided by the content provider. The transcode cluster 1730 allows the encryption cluster 1750 to synchronize (e.g., via rsync) or copy (e.g., via secure copy (SCP)) files from the transcode cluster 1730. Rsync and SCP are common (and public) Linux/Unix utilities to securely copy files using secure shell (SSH) keys between the transcode cluster 1730 and the encryption cluster 1750.

The encryption cluster 1750 reads the encrypt message 1741 from the encryption queue 1740 and securely downloads the encoded video format 1702 from the transcode cluster 1730. The encrypt message 1741 includes the IP address of the transcode cluster 1730 and the encoded video format 1702 (e.g., a file code). After the encryption cluster 1750 downloads the encoded video format 1702, the transcode cluster 1730 deletes the encoded video format 1702. The encryption cluster 1750 packages the encoded video format 1702 into an encrypted video stream 1703 using an encryption packaging tool based on the specified platform. The encryption packaging tool includes, but are not limited to, PLAYREADY® for MICROSOFT° platform, WIDEVINE® for ANDROID° platform and FAIRPLAY° for APPLE° IOS® platform. According to one embodiment, the DRM cluster 1750 is based on an online web service (e.g., AMAZON® Elastic Compute Cloud provided by AMAZON WEB SERVICES®) that provides resizable compute capacity on the Internet. The encryption cluster 1750 deletes the encoded video format 1702 after packaging.

The encrypted video stream 1703 from the encryption cluster 1750 is stored in a storage server 1760 (e.g., AMAZON® Simple Storage Service (S3)) provided by AMAZON WEB SERVICES®). According to one embodiment, the encryption cluster 1750 determines whether to package the encoded video format 1702 based on the encryption setting provided by the content provider. If encryption is not required, the storage server 1760 stores the encoded video format 1702 directly from the transcode cluster 1730. The encryption cluster 1750 deletes the encrypted video stream 1703 after the storage server 1760 stores the encrypted video stream 1703.

When a viewer selects a video in the custom channel on his/her device 1780 of a particular platform type, the content delivery network 1770 delivers the encrypted video stream 1703 (or the encoded video format 1702) to the viewer's device 1780 with the specified platform. According to one embodiment, the content delivery network 1770 is an edge delivery network (e.g., AMAZON® CloudFront provided by AMAZON WEB SERVICES®) that distributes content to end-users using a network of edge locations.

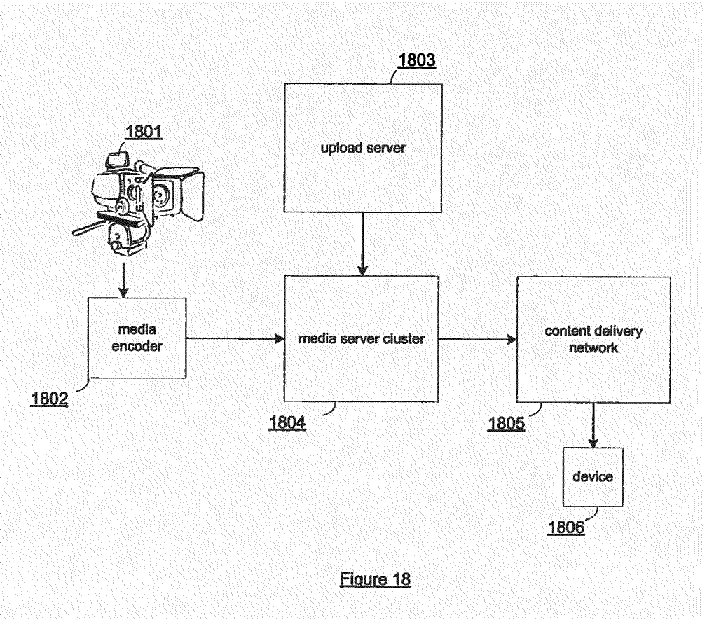

FIG. 18 illustrates a block diagram of an exemplary system for delivering a live event to a device, according to one embodiment. The upload server 1803 schedules a live event for real-time streaming based on the live event settings (e.g., name, description, poster, start time, always on/one-time event) as specified by a content provider. The upload server 1803 further contains the configurations of various templates (e.g., content settings, appearance settings and pricing settings) for a custom channel and specified platforms to deliver the live event on the custom channel as specified by the content provider.

A media encoder 1802 streams audio and video in real-time from a video camera 1801 to a media server cluster 1804 using real time messaging protocol (RTMP), according to one embodiment. The media encoder 1802 includes, but is not limited to, third party encoders (e.g., ADOBE® FLASH® media live encoder).

The media server cluster 1804 encodes the live stream into a target encoded live stream that is suitable for playback on the specified platform. The media server cluster 1804 further provides dynamic encryption of the encoded live stream into an encrypted live stream based on the specified platform. The media server cluster 1804 is based on, but not limited to, media servers (e.g., ADOBE® FLASH® media server).

The content delivery network 1805 receives the encrypted live stream from the media server cluster 1804. When a viewer selects the live event for viewing in the custom channel on his/her device 1806 with the specified platform at the date and time specified by the content provider, the content delivery network 1805 delivers the encrypted live stream to the viewer's device 1806.

According to one embodiment, the content provider provides a content feed to the present publishing system via a web interface in the form of a content feed (e.g., MRSS feed). The content feed has a feed URL (e.g., http://search.yahoo.com/mrss/) which includes tags that are used to control the behavior, and user experience of the application, including restricting content access to certain countries (geo-filtering), specifying up to two levels of categories for each item, specifying poster art for each item, featuring items, and control the order of featured items, and creating episodic content.

For example, an exemplary feed URL is defined as follows:

```
<?xml version=”1.0” encoding=”utf-16”?>
<rss version=“2.0” xmlns:media=“http://search.yahoo.com/mrss/”>
<channel>
<item>
<pubDate>10/13/2011</pubDate>
<media:content url=“http://www.myserver.com/videos/raw-video.mpg”
            duration=“9021.08”
                sourceId=“123”/>
<media:title type=“plain”></media:title>
  <media:description type=“plain”></media:description>
<media:thumbnail url=“http://www.myserver.com/raw-
video.jpg”></media:thumbnail>
<media:rating scheme=“urn:mpaa”>PG</media:rating>
<media:restriction relationship=“allow”
type=“country”>us</media:restriction>
<media:community>
      <media:starRating average=“75” count=“” min=“1” max=“100” />
      <media:statistics views=“3” favorites=“” />
</media:community>
<media:category>Action</media:category>
<media:category>Drama</media:category>
<media:category scheme=”urn:skychnl:featured”>1</media:category>
</item>
</channel>
</rss>
```

The feed URL includes a content tag (e.g., media:content) that defines attributes of the content. For example, the content tag is defined as follows:

<media:content
url=“http://www.foo.com/movie.mov”
fileSize=“12216320”
type=“video/quicktime”
medium=“video”
isDefault=“true”
expression=“full”
bitrate=“128”
framerate=“25”
samplingrate=“44.1”
channels=“2”
duration=“185”
height=“200”
width=“300”
lang=“en” />

Other additional tags that define the attributes of the content include a rating tag, a title tag, a description tag, a thumbnail tag, a category tag, a restriction tag, a community tag, and a price tag. The rating tag (e.g., media:rating) displays age appropriateness for the content. The title tag (e.g., media:title) displays a title of the content. The description tag (e.g., media:description) displays a description for the content. The thumbnail tag (e.g., media:thumbnail) displays poster art for the content, The category tag (e.g., media:category) displays categories for various levels (e.g., up to two levels). The restriction tag (e.g., media:restriction) displays countries that are restricted from playing the content. According to one embodiment, the restriction tag displays countries that are allowed to play the content. The restriction tag includes a relationship attribute that can be either configured as allow or deny. A content provider may configure the relationship attribute of the restriction tag as allow to indicate countries listed that are allowed to play the content. Alternatively, the content provider may configure the relationship attribute as deny to indicate countries that are restricted from playing the content. The community tag (e.g., media:community) displays ratings for the content. The price tag (media:price) displays a price for viewing the content.

According to one embodiment, a scheme attribute is added to the category tag to specify a categorization scheme. The category tag is used in combination with a scheme attribute to control the order of display of contents. For example, a category tag that specifies an item as the first featured item to display to a viewer is defined as follows:

<media:category scheme=“urn:skychnl:featured”>1</media:category>

According to another embodiment, the category tag is used in combination with a scheme attribute to specify episodic content. Typically, episodic content includes two parts: series and episodes. A label attribute may be added to the category tag for a human-readable label. The label attribute associates episodes with a series. The scheme attribute identifies a video as a series or episode. A series represents a group of episodes while each episode is associated with a particular series. In one embodiment, the order of the episode is specified by specifying the series and episode number separated by a “.”. For example, an episode number 1 of series number 1 with a series label s01 is specified as 1.1 as the category value. The category tag for series label s01 is defined as follows:

media:category scheme=“urm.skychnl.series”label=“s01”> </media:category>
For episode number 1 of series number 1, the category tag is defined as follows:
media:category scheme=“urn.skychnl:episode”label=“s01”>1.1</media:category>
In this way, the user interface of the custom channel provides a view to select a specific episode from a specific series.

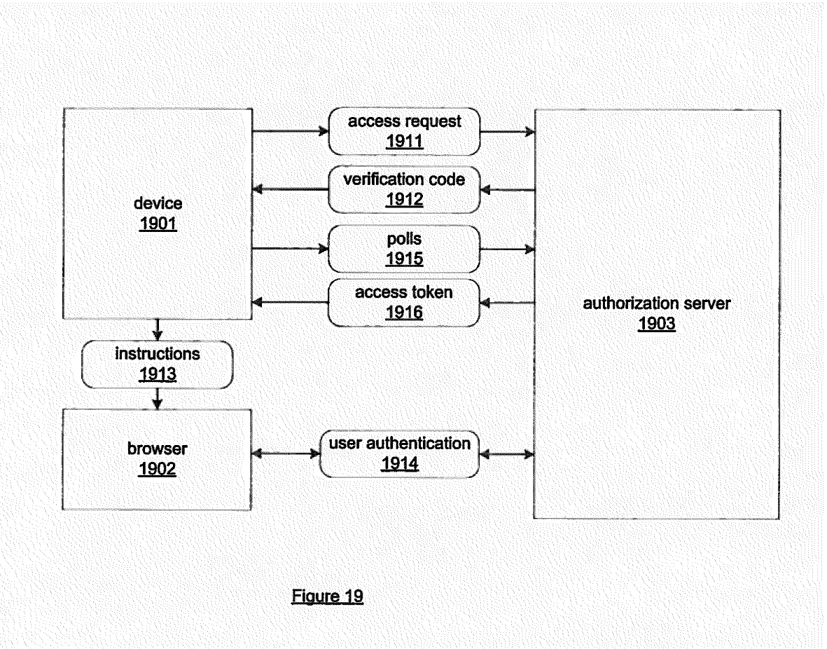

According to one embodiment, the present system provides a device activation API request to activate a viewer's device with a social network (e.g., FACEBOOK®). The API request may be sent via hypertext transfer protocol secure (HTTPS) for secure communication or other types of communications protocol known to one ordinary skilled in the art. FIG. 19 illustrates a block diagram of an exemplary process of activating a device with a social network, according to one embodiment. The custom channel application of the device 1901 provides an access request 1911 to the authorization server 1903 of a social network. The authorization server 1903 returns a verification code 1912 to the device 1901. The device 1901 provides instructions 1913 on a screen of the device 1901 to a user to access the web user interface 1902 of the authorization server 1903. The authorization server 1913 provides the user with authentication 1914 based on the verification code 1912 via the browser 1902 and prompts the user to authorize the device's 1901 access request. While the user authorizes (or denies) the device's 1901 access request, the device 1901 repeatedly polls 1915 the authorization server 1903 to find out if the user has completed the authorization process. If the user authorizes the device's 1901 access request, the authorization server 1903 validates the verification code 1912 and returns an access token 1916 to the device 1901. Therefore, the access token 1916 identifies a social network user ID of the user with the user ID of the same user stored in the present system. The device 1901 updates itself with the access token 1916 to complete activation of the device 1901. The present system receives the access token 1916 from the device 1901 and stores the authentication information from the access token 1916 into a viewer database.

According to one embodiment, the present system provides a user API request to a viewer's device after a viewer downloads the custom channel from an online application store and logs into the custom channel on his/her device. The present system provides the user API request to receive user details (e.g., IP address, external facing IP, billing status, expiry date), and user subscription status (e.g., IP address, external facing IP, subscription expiry and country code). The user API request determines if an external user ID (e.g., FACEBOOK® ID) of the viewer used for logging in is associated with an existing user ID of the present system. If there is an association, the external user ID is merged with the existing user ID of the present system and deleted. If the external user ID is new, then an association to a user ID of the present system is made.

According to one embodiment, the present system provides a watch list API request to the device to receive video details (e.g., video ID, thumbnail, video size, video array) that a viewer has placed into a queue for viewing.

According to one embodiment, the present system provides a video API request to retrieve video details from a viewer's device, The video API request may determine if a video can be played in a country of the viewer by comparing an excluded list of countries for a video with the country code returned by the user API request. The video API request may further determine a current playing position of a video and adds the video to a progress queue (e.g., based on >25% watched but <99% watched). The video API request may determine a current playing position of a video and prompts the viewer to continue watching (e.g., based on >25% watched).

According to one embodiment, the present system provisions to the content provider's advertisement server in order to display clickable banner advertisements and video advertisements in the custom channel. As discussed earlier, the present system allows a content provider to configure the type of advertisements as illustrated in FIG. 12. According to one embodiment, the present system includes an advertisement server (e.g., DOUBLECLICK BY GOOGLE®) that allows a content provider to plug-in his/her third party advertisement server (e.g., LIVERAIL®). The present advertisement server receives and processes a request for an advertisement from the third-party advertisement server before forwarding the advertisement to the custom channel. The present system makes an advertisement API request call and reformats a variation of an advertisement response into a uniform format for the custom channel. According to one embodiment, advertisements are served to the custom channel based on a video advertisement serving template (VAST) specification.

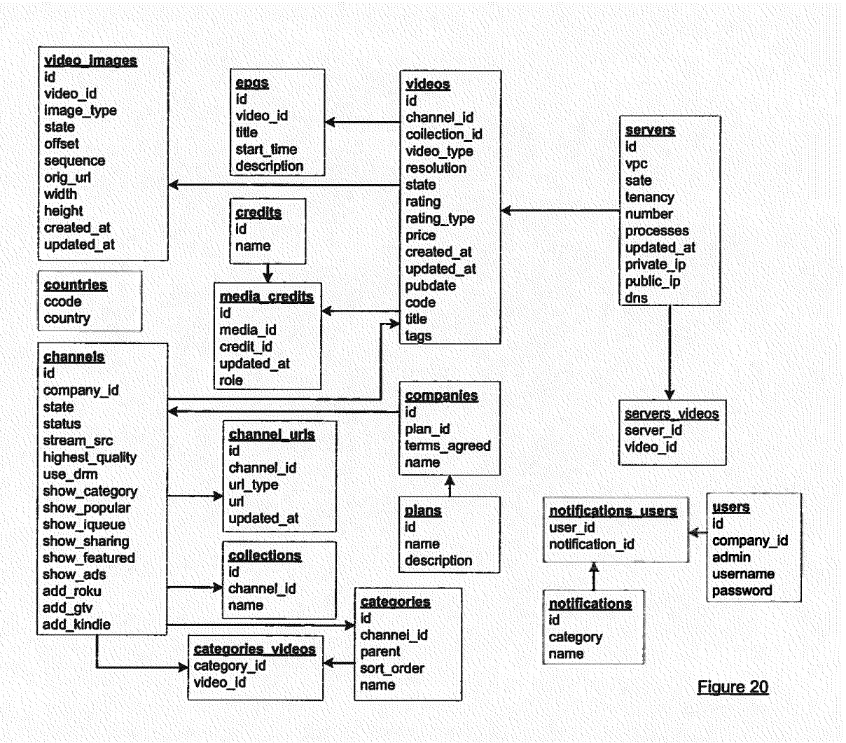

FIG. 20 illustrates an exemplary data model that is used for the present system, according to one embodiment. The data model provides a description of the objects (e.g., videos, channels, companies and users) represented by the present system together with their properties and relationships. For example, a channel is related to videos, and videos are related to video images.

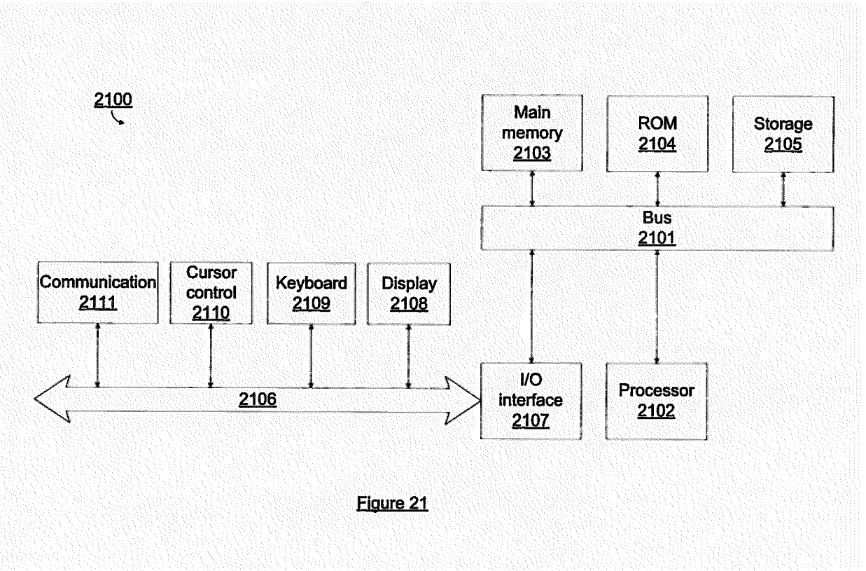

FIG. 21 illustrates an exemplary computer architecture that may be used for the present system, according to one embodiment. The exemplary computer architecture may be used for implementing one or more components described in the present disclosure including, but not limited to, the present system. One embodiment of architecture 2100 includes a system bus 2101 for communicating information, and a processor 2102 coupled to bus 2101 for processing information. Architecture 2100 further includes a random access memory (RAM) or other dynamic storage device 2103 (referred to herein as main memory), coupled to bus 2101 for storing information and instructions to be executed by processor 2102. Main memory 2103 also may be used for storing temporary variables or other intermediate information during execution of instructions by processor 2102. Architecture 2100 may also include a read only memory (ROM) and/or other static storage device 2104 coupled to bus 2101 for storing static information and instructions used by processor 2102.

A data storage device 2105 such as a magnetic disk or optical disc and its corresponding drive may also be coupled to architecture 2100 for storing information and instructions. Architecture 2100 can also be coupled to a second I/O bus 2106 via an I/O interface 2107. A plurality of I/O devices may be coupled to I/O bus 2106, including a display device 2108, an input device (e.g., an alphanumeric input device 2109 and/or a cursor control device 2110).

The communication device 2111 allows for access to other computers (e.g., servers or clients) via a network. The communication device 2111 may include one or more modems, network interface cards, wireless network interfaces or other interface devices, such as those used for coupling to Ethernet, token ring, or other types of networks.

The above example embodiments have been described hereinabove to illustrate various embodiments of implementing a system and method for multimedia content publishing on multiple platforms. Various modifications and departures from the disclosed example embodiments will occur to those having ordinary skill in the art. The subject matter that is intended to be within the scope of the invention is set forth in the following claims.

We claim:

1. A computer-implemented method, comprising:
receiving specified settings from a plurality of configurable template settings for a custom channel application;
receiving specified platforms from a plurality of platforms for the custom channel application;
publishing the custom channel application to each of the specified platforms; and
providing a user interface of the custom channel application that is customized based on each of the specified platforms.

2. The computer-implemented method of claim 1, wherein the plurality of configurable template settings comprises one or more of content settings, appearance settings, pricing settings, feature settings and report settings.

3. The computer-implemented method of claim 1, further comprising:
receiving a content file for the custom channel application; and
delivering the content file in the custom channel application to each of the specified platforms,

4. The computer-implemented method of claim 3, wherein the content file comprises one or more of an image, an audio, a video, a document and an executable.

5. The computer-implemented method of claim 3, further comprising receiving the content file from a device.

6. The computer-implemented method of claim 3, further comprising receiving the content file from a content feed.

7. The computer-implemented method of claim 3, further comprising tagging the content file to a category.

8. The computer-implemented method of claim 3, further comprising tagging the content file as an episode of a series, wherein the series comprises a plurality of episodes.

9. The computer-implemented method of claim 3, further comprising delivering a plurality of content files in the custom channel application to each of the specified platforms based on a schedule, wherein the schedule associates a date and a time for each of the plurality of content files.

10. The computer-implemented method of claim 3, further comprising receiving the content file from a live video stream via a real time messaging protocol.

11. The computer-implemented method of claim 10, further comprising delivering the content file in the custom channel application to each of the specified platforms based on a date and a time.

12. The computer-implemented method of claim 2, wherein the appearance settings comprise one or more of an aspect ratio, a title bar, a background screen and a welcome screen.

13. The computer-implemented method of claim 3, further comprising encoding the content file based on each of the specified platforms.

14. The computer-implemented method of claim 13, further comprising encrypting the encoded content file based on each of the specified platforms.

15. The computer-implemented method of claim 1, further comprising providing an advertisement to the custom channel application, wherein the advertisement comprises one or more of a banner advertisement and a video advertisement.

16. A non-transitory computer readable medium having stored thereon computer-readable instructions, and a processor coupled to the non-transitory computer readable medium, wherein the processor executes the instructions to:
receive specified settings from a plurality of configurable template settings for a custom channel application;
receive specified platforms from a plurality of platforms for the custom channel application;
publish the custom channel application to each of the specified platforms; and
provide a user interface of the custom channel application that is customized based on each of the specified platforms.

17. The non-transitory computer readable medium of claim 16, wherein the plurality of configurable template settings comprises one or more of content settings, appearance settings, pricing settings, feature settings and report settings.

18. The non-transitory computer readable medium of claim 16, wherein the processor executes the instructions to:
receive a content file for the custom channel application; and
deliver the content file in the custom channel application to each of the specified platforms,

19. The non-transitory computer readable medium of claim 18, wherein the content file comprises one or more of an image, an audio, a video, a document and an executable.

20. The non-transitory computer readable medium of claim 18, wherein the processor executes the instructions to receive the content file from a device.

21. The non-transitory computer readable medium of claim 18, wherein the processor executes the instructions to receive the content file from a content feed.

22. The non-transitory computer readable medium of claim 18, wherein the processor executes the instructions to tag the content file to a category.

23. The non-transitory computer readable medium of claim 18, wherein the processor executes the instructions to tag the content file as an episode of a series, wherein the series comprises a plurality of episodes.

24. The non-transitory computer readable medium of claim 18, wherein the processor executes the instructions to deliver a plurality of content files in the custom channel application to each of the specified platforms based on a schedule, wherein the schedule associates a date and a time for each of the plurality of content files.

25. The non-transitory computer readable medium of claim 18, wherein the processor executes the instructions to receive the content file from a live video stream via a real time messaging protocol.

26. The non-transitory computer readable medium of claim 25, wherein the processor executes the instructions to deliver the content file in the custom channel application to each of the specified platforms based on a date and a time.

27. The non-transitory computer readable medium of claim 17, wherein the appearance settings comprise one or more of an aspect ratio, a title bar, a background screen and a welcome screen.

28. The non-transitory computer readable medium of claim 18, wherein the processor executes the instructions to encode the content file based on each of the specified platforms.

29. The non-transitory computer readable medium of claim 28, wherein the processor executes the instructions to encrypt the encoded content file based on each of the specified platforms.

30. The non-transitory computer readable medium of claim 16, wherein the processor executes the instructions to provide an advertisement to the custom channel application, wherein the advertisement comprises one or more of a banner advertisement and a video advertisement.
